(19) United States
(12) Patent Application Publication
(10) Pub. No.: US 2016/0335576 A1
(43) Pub. Date: Nov. 17, 2016

(54) LOCATION-BASED PREDICTION OF TRANSPORT SERVICES

(71) Applicant: UBER Technologies, Inc., San Francisco, CA (US)

(72) Inventor: Yefei Peng, Palo Alto, CA (US)

(21) Appl. No.: 14/709,799

(22) Filed: May 12, 2015

(51) Int. Cl. G06Q 10/06; G08G 1/00

(52) U.S. Cl. CPC G06Q 10/06315; G08G 1/202

(57) ABSTRACT

A dispatch system is provided to collect and store historical passenger pick-up and drop-off data. The dispatch system can utilize the historical data to construct correlation models that identify spike pairs each comprising a spike in passenger drop-offs and an associated spike in passenger pick-ups at a given location. The spike pairs can be indicative of an event at an event location having a typical duration. The dispatch system can detect a current spike in passenger drop-offs at a respective event location, and predict an associated spike in pick-up requests after a given duration at the event location using the historical data and correlation models.

### BACKGROUND

With the advent of application-based network technologies, various transportation services are increasingly becoming more efficient.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram illustrating an example system for predicting and servicing pick-up request spikes at a given event location;

FIG. 2 is a high level flow chart illustrating an example method for predicting and servicing pick-up request spikes at a given event location;

FIG. 3 is a low level flow chart illustrating an example method for predicting and servicing pick-up request spikes at a given event location;

FIG. 4A is a flow chart illustrating an example method for matching a current drop-off spike with a correlation model;

FIG. 4B is a flow chart illustrating an example method for transmitting demand notifications to transport vehicles based on a given spike forecast;

FIG. 5A is an example screenshot of a demand notification for a driver device;

FIG. 5B is an example screenshot of an avoidance notification for a user device;

FIG. 6 is a block diagram illustrating a computer system upon which examples described herein may be implemented; and

FIG. 7 is a block diagram illustrating a mobile computing device upon which examples described herein may be implemented.

### DETAILED DESCRIPTION

A dispatch system is provided that can compile service data and build correlation models based on the compiled data. For example, the dispatch system can identify passenger drop-off spikes and corresponding passenger pick-up spikes at or near certain event locations (also referred to herein as venues). These spike pairs can be associated with the start and completion of an event (e.g., a sporting event, a concert, a business conference, etc.). Each event type (and/or subtype) may have any number of identifying characteristics unique to that type. For instance, an opera may only occur at a finite number of venues within a given region (e.g., in a geofenced region corresponding to San Francisco, Calif.), and will typically start at a certain time of the day or evening (e.g., 6:00 pm). Additionally, a typical event may be attended by a predictable number, or number range, of spectators. Furthermore, events within a region may only occur seasonally over a span of five or six months (e.g., September through January for professional football games), and each event may only take place on certain days of the week (e.g., Sunday and Monday). Still further, events may share a durational characteristic in which a typical event, such as an opera, will last between two and two-and-a-half hours. Accordingly, the dispatch system can build correlation models for perceived spike pairs based on such unique characteristics.

As a specific example, a drop-off spike may comprise 95 drop-offs at or near the John F. Kennedy Center for the Performing Arts in Washington D.C. between 5:15 pm and 5:45 pm. The 95 drop-offs can have occurred within a geofenced region corresponding to the JFK Center and surrounding street blocks, or within a specified distance from the JFK Center. A corresponding pick-up spike may comprise 80 pick-up requests at the same location or region between 9:45 pm and 10:15 pm. The dispatch system may associate these two spikes as a spike pair for an event that takes place at the JFK Center. The dispatch system may also compile this spike pair with similar spike pairs in a correlation model for performance events—with each spike pair in the correlation model having similar characteristics such as time of event, location, duration, volume of spike pairs, volume ratio between spike pairs, etc. Such characteristics may be static—such as the location—or variable, such as the duration or spike volume.

Furthermore, correlation models for certain event types may vary in granularity based on subtype. As an example, a coarse correlation model for professional football games at Jack Kent Cooke Stadium in Washington D.C. may indicate drop-off spikes having volumes between 640 and 1,200 drop-offs, and 620 and 1,175 pick-ups. A finer correlation model for professional football games at Jack Kent Cooke Stadium may indicate games in which popular or rival teams (e.g., the Denver Broncos) are in town. This finer correlation model may account for a chunk of the range in the identified spikes. For example, spike pairs for these popular games may indicate between 1,090 and 1,200 drop-offs, and 1,015 and 1,175 pick-ups. Thus, the dispatch system can compile coarse correlation models for event types and event locations, and subdivide these coarse models into event subtypes associated with finer correlation models.

In accordance with examples discussed herein, the dispatch system can detect a current spike in drop-offs at a particular event location. The dispatch system can run a comparison operation to compare the current spike in drop-offs with the stored correlation models. The comparison operation can comprise a series of filter operations to eliminate nonmatching correlation models and narrow down matching correlation models. For example, the dispatch system can eliminate correlation models having nonmatching event locations. In addition, the dispatch system can eliminate correlation models based on drop-off volume (e.g., those having a drop-off volume range outside the detected current spike in drop-offs). The dispatch system can then identify a most probable correlation model (and/or the most probable event corresponding to the current spike in drop-offs). Based on an average or mean duration for the event and associated pick-up spike indicated in the matching correlation model, the dispatch system can generate a demand notification for transmission to local transport providers or vehicles to fulfill the anticipated spike in pick-up requests. Alternatively, upon identifying a matching correlation model, the dispatch system can further parse through individual spike pairs, or spike pair groupings (e.g., finer correlation models), to identify a most closely matching drop-off spike or spike group. The dispatch system can identify the associated pick-up spike for this matching drop-off spike or spike group, and thus transmit demand notifications (e.g., demand surge alerts) to a selected number of drivers to fulfill the anticipated demand spike.

Among other benefits, examples described herein achieve a technical effect of making transportation services more efficient. Current transportation services lack data gathering on a scale to integrate, correlate, and model event characteristics to accurately forecast demand spikes associated with specified events. Using a multitude of data gathered comprising, for example, timestamps and locations for drop-offs and pick-ups, corresponding event locations, event schedule information gathered from information resources, weather data, and identified drop-off and pick-up spike pairs, a dispatch system may construct correlation models to forecast a demand spike (e.g., a surge in passenger pick-up requests) for a given spike in passenger drop-offs at a given location. Based on the forecasted demand spike, the dispatch system can submit demand notifications to transport vehicles in order to anticipate the forecasted demand spike and service passenger pick-up requests more efficiently.

As used herein, a computing device, a user device, a driver device, etc., refer to devices corresponding to desktop computers, cellular devices or smartphones, personal digital assistants (PDAs), laptop computers, tablet devices, television (IP Television), etc., that can provide network connectivity and processing resources for communicating with the system over a network. A computing device can also correspond to custom hardware, in-vehicle devices, or on-board computers, etc. The computing device can also operate a designated application configured to communicate with the dispatch system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples disclosed herein can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

### System Description

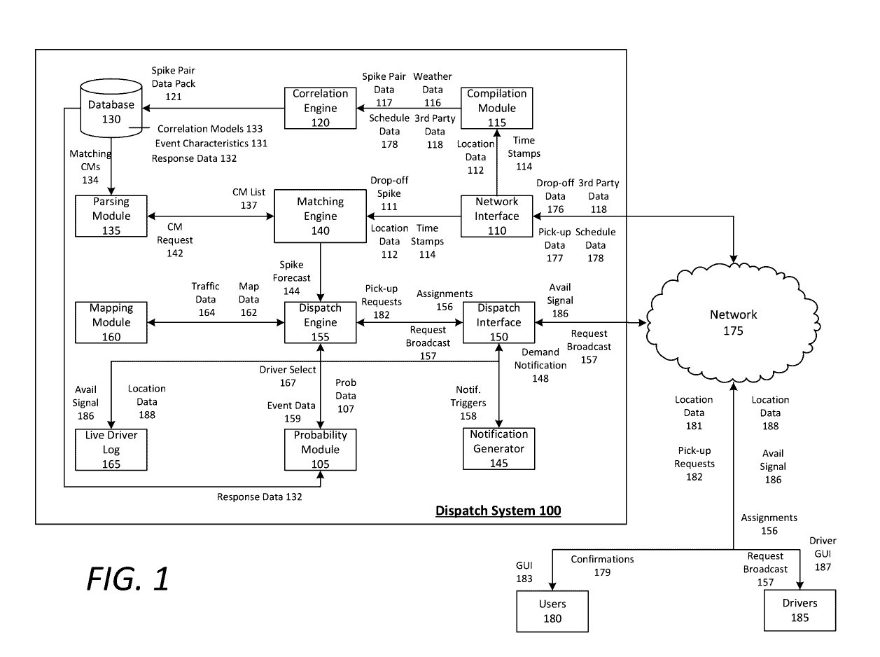

FIG. 1 is a block diagram illustrating an example system for predicting and servicing pick-up request spikes at a given event location. A dispatch system 100 can arrange transport services for users 180 using location-based resources of the computing devices of the users 180 and available drivers 185. As used herein, “a user 180” or “a driver 185” can also refer to the computing device operated by the respective person. A graphic user interface (GUI) 183—for example, a GUI associated with a designated application that communicates with a dispatch system 100—can be generated on individual user devices to enable users 180 to request a passenger pickup for transport to a specified location. A dispatch engine 155 can receive such pick-up requests 182 and issues assignments 156 to drivers 185—using a driver GUI 187 generated on the respective driver devices—to fulfill such requests 182. Accordingly, over a given time, a multitude of data comprising, for example, timestamps and locations for passenger drop-offs and pick-ups, corresponding event locations, event schedule information gathered from information resources, weather data, etc., can be gathered by the dispatch system 100.

According to various implementations, the dispatch system 100 can include a network interface 110 to receive drop-off data 176 and pick-up data 177 from user devices and/or driver devices over a network 175. As described herein, each time a transport service is completed at a particular location (e.g., as indicated by the driver 185 via the driver GUI 187 when arriving at a destination location and dropping off the passenger), the corresponding drop-off data 176 can specify the drop-off location and the time of drop-off (e.g., date and/or time). Similarly each time a transport service starts at a particular location (e.g., the pickup location), the corresponding pick-up data 177 can specify a pick-up location and the time of pick-up. In this manner, for each drop-off event and pick-up event, the drop-off data 176 and the pick-up data 177 can include location data 112 and corresponding timestamps 114. Furthermore, the drop-off data 176 and pick-up data 177 can be received directly from the users 180 and the drivers 185 in real-time, and can further be compiled by the dispatch system 100 over any given time period.

In many examples, the dispatch system 100 can include a compilation module 115 to parse through the received data (i.e., the drop-off data 176 and the pick-up data 177, including location data 112 and timestamps 114) to identify spike pairs each corresponding to (i) a passenger drop-off spike at a given event location, and (ii) a passenger pick-up spike at the same event location (e.g., a concert hall, a sporting venue, a travel port, a convention or exhibition complex, etc.) after a given duration of time (e.g., time periods ranging from several minutes to days or even weeks). As referred to herein, a “spike” can correspond to a number of drop-off events or pick-up events that occur in a given location or region for a duration of time. Such spike pairs can be related to entertainment events such as sporting events and music or performing arts events, business or political conferences, protest events, conventions, festival events, local celebrations or traditional events, holiday events, participatory and charitable events, and the like.

Accordingly, the compilation module 115 can identify such spike pair data 117, which can include the number or volume of drop-offs as compared to the number or volume of pick-ups (“the volume ratio”), the event location, the event duration, etc. Furthermore, for each given spike pair identified, the compilation module 115 can pull further data from the network 175 to provide more detail with regards to the spike pair. In some examples, given a specific spike pair associated with an event location, the compilation module 115 can search the network 175 for schedule data 178 for the event location and correlation an event type (e.g., a baseball game) and/or a specific event (e.g., a baseball game between the Nationals and the Marlins). In variations, the compilation module 115 can search the network 175 for weather data 116 for the given event. In similar variations, the compilation module 115 can comb third-party resources, such as news resources or sources associated with the event location, to identify third-party data 118 that may be useful for constructing a data pack 121 for the spike pair.

The compilation module 115 can submit the spike pair data 117, the weather data 116, the schedule data 178, and/or the third party data 118 to a correlation engine 120 of the dispatch system 100. The correlation engine 120 can use the received data to construct a spike pair data pack 121 in order to match the spike pair to one or more correlation models 133 stored and managed in a database 130. The correlation engine 120 can incorporate the spike data 117—comprising the volume ratio, event location, and event duration—into the data pack 121 for the spike pair. Using this present data pack 121, the correlation engine 120 can scan through or search the correlation models 133 in the database 130 to determine whether the present data pack 121 matches or is similar to a particular correlation model 133. For example, the spike pair data 117 in the data pack 121 can be associated with a very typical and regular event, such as a weekly concert at a public park. These regular events may have fairly static numbers for attendees (e.g., 45-50 spectators), and a set duration (e.g., 45 minutes). Accordingly, the correlation engine 120 can readily identify and select a correlation model 133 including several spike pairs associated with the same, regular event, and input the present data pack 121 into the selected correlation model 133.

However, not all events have such predictable regularity in terms of participation or attendance volume and duration. Accordingly, in many examples, the correlation engine 120 can filter through the stored correlation models 133 based on the data received from the compilation module 115. In some examples, the correlation engine 120 can filter through the correlation models 133 in a hierarchical manner. For example, the correlation engine 120 can initially disregard all correlation models having a nonmatching event location. Thus, no matter the drop-off/pick-up volume for the spike pair, or the duration of the event, the correlation engine 120 can identify only those correlation models in the database 130 having matching event location or venue.

In similar examples, the correlation engine 120 can initially disregard all correlation models having a duration range outside a threshold duration of the present spike pair. For example, the present spike pair may be associated with a baseball game. The correlation engine 120 can determine that baseball games typically range from about two-and-a-half to three hours, and the duration of baseball games can be typically envisioned as a normal or Gaussian distribution curve with a set minimum duration, a set maximum duration, and a peak at around three hours. The correlation engine 120 can determine that no baseball game has ever had a duration of less than about an hour, and therefore all correlation models in the database 130 having a maximum duration range under an hour may be excluded. The correlation engine 120 may do the same for maximum duration, and thus exclude all correlation models in the database 130 having a minimum duration range over say, ten hours.

Such coarse filtering may suffice for the correlation engine 120 to match the present spike pair with a specified correlation model 133 in the database 130. In certain implementations, the correlation engine 120 can refine the filtering process with regards to, or regardless of, a confident match being found. The correlation engine 120 can utilize the schedule data 178 for the event location associated with the present spike pair in order to identify the event itself. Accordingly, the correlation engine 120 can filter out correlation models 133 having differing event types. In variations, the correlation engine can further identify a subtype (e.g., a pop concert as opposed to a folk concert at the same venue), and match the present data pack 121 for the identified spike pair with a subtype or subclass of a matching correlation model 133. Third party data 118 may be included in the data pack 121, and may be utilized to further identify or support a match. For example, user review sites including user reviews indicating a popularity of an event may account for greater volume in passenger drop-offs and pick-ups at the event. Furthermore, weather data 116 may be included to account for an anomaly in the spike data 117, such as a rain delay or a decrease in attendance for the event (hence a decrease in drop-offs and pick-ups).

In certain implementations, the correlation engine 120 can scan the schedule data 178, the weather data 116, and/or the third party data 118 in response to detecting an anomaly in the spike pair data 117. For example, an exceptionally high drop-off spike paired with an exceptionally low pick-up spike may be considered an anomaly (e.g., a volume ratio outside of predetermined norms). The correlation engine 120 can comb through the additional data in order to identify an explanation for the anomaly, and hence create more refined correlation models 133 that account for such anomalies. Thus, the correlation engine can construct fine correlation models 133 that account for, for example, weather delays in sporting events, abnormal attendance at a concert venue, combinations of events at an event location (e.g., a political protest at a business conference), etc.

In accordance with examples described herein, the correlation engine 120 can compile coarse and refined correlation models 133 each having common event characteristics 131 indicative of the associated event. As used herein, a “common” event characteristic may be a common event location for each spike pair in the correlation model. A common event characteristic may further describe a set of data items within a predetermined range of a stated value, such as an average or median value. For example, a common volume of passenger drop-offs and/or a common volume of passenger pick-ups can comprise a number of passenger drop-offs or passenger pick-ups over a given duration within a certain percentage (e.g., 90%) of an average, mean, or expected value (e.g., an average number of pick-ups or drop-offs for a given event). As another example, a common duration may be an identified or determined duration within a given time range or range percentage, such as within 90% of an average, mean, or expected duration. For each spike pair detected by the compilation module 115, the correlation engine 120 can perform the same or similar process of constructing a data pack 121, filtering, and matching the spike pair to one or more discrete coarse and/or fine correlation models 133 as described above.

In many applications, these correlation models 133 can be utilized by the dispatch system 100 to predict a spike in pick-up requests 182 given a detected current drop-off spike 111. Specifically, during normal operations, users 180 can submit pick-up requests 182 via the designated application, which can be received by the network interface 110 in real-time. In examples herein, the pick-up requests 182 can include specified pick-up locations corresponding to the current location of respective users 180 or inputted by respective users 180. The pick-up requests 182 may indicate a drop-off location, or additionally or alternatively, the drop-off locations may be identified at the conclusion of each transport service. From this drop-off data 176, a matching engine 140 of the dispatch system 100 may identify a current drop-off spike 111 within a certain time range at a given event location.

Each drop-off event may include location data 112 and a timestamp 114 indicative of the current drop-off spike 111. For example, a drop-off spike 111 may be identified in a region including and surrounding a concert hall, indicating an upcoming concert. Using the data associated with the drop-off spike 111, the matching engine 140 can compile a correlation model request 142 indicating the event location, the time of the current drop-off spike 111, and the volume of the current drop-off spike 111. In one example, the dispatch system 100 can include a parsing module 135 to parse the correlation model request 142 to retrieve a number of matching correlation models 134 from the database 130. In some examples, the parsing module 135 may find a single matching correlation model in the database 130 for submission to the matching engine 140. In such examples, the matching engine 140 can identify a predicted pick-up request spike in the matching correlation model, and submit a forecast for the predicted pick-up request spike to a dispatch engine 155 for processing. In other examples, the parsing module 135 can identify a plurality of matching correlation models 134, and submit a correlation model list 137 to the matching engine 140 for further processing.

The correlation model list 137 can include any number of coarse and/or fine correlation models 133. The goal of the matching engine 140 is to identify, based on the current drop-off spike 111, a matching pick-up spike in the matching correlation models 134. According to various examples, the matching engine 140 can map a temporal width of the current drop-off spike 111 with the drop-off spikes in the matching correlation models 134. Similarly, the matching engine 140 can map a volume height of the current drop-off spike 111 with those in the matching correlation models 134. Presumably all matching correlation models 134 include the same event location, however if that is not the case, the matching engine 140 can exclude those that have nonmatching event locations.

In some implementations, the matching engine 140 can refine the matching process. Given a matching volume height and/or temporal width, the matching engine may further account for time of day, day of the week, or even season to determine whether a match is relevant. For example, given similar spikes, the matching engine 140 may preliminarily identify the current drop-off spike 111 as one that is associated with a baseball game. However, the matching engine 140 may identify that the current drop-off spike 111 is being detected in December, which is outside of baseball season, and thus exclude all matching correlation models associated with baseball games.

In some examples, if no initial matches are identified, the matching engine 140 can refine the search to account for anomalies. The matching engine 140 may identify current weather conditions and match the current drop-off spike 111 with a matching correlation model based on each having similar weather conditions. For example, if the current drop-off spike 111 is associated with a baseball stadium, but is well under a normal volume range, the matching engine may identify that weather conditions (e.g., humidity, temperature, rain, etc.) account for the reduced volume. Thus, the matching engine 140 can either refine the correlation model request 142 to account for the weather conditions, or identify in the matching correlation models 134, those that are associated with similar weather conditions. Other anomalies affecting a match can include traffic events, such as building or road construction, news events, venue changes, disaster events, and the like. Given anomalies affecting a current drop-off spike 111, the matching engine 140 may guess a duration and pick-up request spike based on the matching correlation models 134, or otherwise terminate operations if the effect of the anomaly causes too great a disparity.

In various examples, if a precise match is found, the matching engine 140 can identify individual spike pairs in the matching correlation model 134 to identify a most probable spike pair. For example, the current drop-off spike may have a similar temporal width, however, the overall volume of the drop-off spike may be more relevant to identifying a predicted pick-up spike. The matching engine 140 can parse through spike pairs in the matching correlation model 134 in order to identify one or more matching drop-off spikes. Thus, the pick-up spike(s) associated with the one or more matching drop-off spikes can be used to predict a pick-up request spike for the current drop-off spike 111.

Additionally or alternatively, given a set of matching drop-off spikes in the matching correlation model 134, the matching engine 140 can average the associated pick-up spikes, or calculate a mathematical expectation or arithmetic mean for the associated pick-up spikes. The average, or calculated expectation, can be modeled into a predicted pick-up request spike at an estimated duration after the current drop-off spike 111.

Given a matching correlation model 134 and predicted pick-up request spike, the matching engine 140 can generate a spike forecast 144 for the current drop-off spike 111 indicating a predicted spike in pick-up requests 182 at the event location after an estimated or calculated time of the current drop-off spike 111. As described herein, the matching engine 140 may perform such operations in a near-instantaneous manner given a detected current drop-off spike 111. Thus, a current drop-off spike 111 can be detected, the stored correlation models 133 can be parsed, and a spike forecast 144 can be generated by the matching engine 140 in real-time or near real-time. In this manner, based on a drop-off spike 111 detected in real-time or close to real-time, the dispatch system 100 can use the predicted pick-up request spike to perform one or more operations at a later time in order to alleviate any potential supply constraints at the event location in the future.

In various examples, the matching engine 140 can submit the spike forecast 144 to the dispatch engine 155 of the dispatch system 100. The dispatch engine 155 can process the spike forecast 144 to alleviate or otherwise anticipate a projected supply shortfall in servicing pick-up requests 182. The dispatch engine 155 can receive map data 162 and/or traffic data 164 from a mapping module 160 (or map database) of the dispatch system 100 to identify the event location. The dispatch engine 155 can further receive location data 188 of available drivers 185, such as location data points determined from a global positioning system (GPS) receiver operating on the driver devices. For example, drivers 185 indicating availability for transport service can initiate a designated application on a computing device, which can generate a driver GUI 187. The designated application on a driver device can transmit an availability signal 186 (e.g., the current state information of the driver 185, such as on-duty or on-trip) and location data 188 to a dispatch interface 150 of the dispatch system 100. In some examples, the dispatch interface 150 can correspond to or be a part of the network interface 110. The dispatch engine 155 can utilize the availability signal 186 and the location data 188 for each of the drivers as an extension of the map data 162 and traffic data 164 in order to manage a live driver log 165.

The live driver log 165 can include all available drivers and their respective locations within a given region. The live driver log 165 can dynamically change in response to the availability of drivers 185. Furthermore, the live driver log 165 can be utilized by the dispatch engine 155 in order to select optimal drivers to service each respective pick-up request 182. The dispatch engine 155 can parse the spike forecast 144 to identify event data 159. Based on the event data 159, a probability module 105 of the dispatch system 100 can calculate probabilities for given numbers of transport vehicles required to service the anticipated spike in pick-up requests 182 at the event location. The probability module 105 can further determine, based on historical response data 132 and the number of current available drivers 185 proximate to the event location, a probable amount of requests or notifications to provide to other available drivers to mitigate the anticipated supply shortage. The probability module 105 can submit this probability data 107 to the dispatch engine 155 to assist in triggering notifications 158 and driver selections 167.

The dispatch engine 155 can send a notification trigger 158 to a notification generator 145 of the dispatch system 100 to generate a demand notification 148 upon receiving the spike forecast 144 and identifying the event location. The notification generator 145 can submit the demand notification 148 to the dispatch interface 150 for transmission to all drivers, available or unavailable, within a given radius of the event location.

Alternatively, the dispatch engine 155 can parse the spike forecast 144 for the event location and predicted pick-up request volume, and consult the live driver log 165 to select a set of drivers in proximity of the event location. For example, the spike forecast 144 may indicate a predicted pick-up request spike of 500 pick-up requests that is predicted to occur at a later or future time (e.g., the spike forecast 144 is determined around noon shortly after the drop-off spike is detected, and the predicted pick-up request spike is to start at 3:00 pm). At a predefined time (e.g., 15 minutes) before this future time when the predicted pick-up request spike is to occur, e.g., 2:45 pm, the dispatch engine 155 can identify, via the map data 162 and live driver log 105, a number of drivers that are readily available proximate to the event location (e.g., within a predetermined distance from the event location). The dispatch engine 155 can calculate a relative supply shortage, and based on probability data 107, identify a number of additional drivers to receive the demand notification 148 in order to most effectively mitigate the anticipated supply shortage.

With regards to the example provided, the spike forecast 144 can indicate that a spike in pick-up requests will occur in the near future. For example, based on a spike in drop-offs at or around a baseball stadium, the matching engine 140 can identify that a baseball game has begun. Based on the results of filtering through the correlation models 133, the matching engine 140 can predict that a spike in pick-up requests will begin at a given time coinciding with the end of the baseball game (e.g., three hours after the spike in drop-offs). Historical data for baseball games at that particular stadium may indicate a predicted total volume or a volume range for pick-up requests. The matching engine 140 can utilize this data to compile a spike forecast 144 for the dispatch engine 155. The dispatch engine 155 can determine—using the spike forecast 144, the live driver log 105, the map data 162, and the traffic data 164—an optimal time to generate and submit demand notifications 148 to available and/or unavailable drivers. For example, the dispatch engine 155 may anticipate a given supply shortage based on available drivers proximate to the baseball stadium. The dispatch engine 155 can transmit demand notifications 148 to drivers within a given distance or time from the baseball stadium. The dispatch engine 155 can do so immediately upon predicting the supply shortage, and/or within a given time prior to the predicted spike in pick-up requests. In some examples, the dispatch engine 155 can performed a tiered notification transmission process, in which more and more drivers within proximity of the baseball stadium are notified of the predicted spike in pick-up requests as the end of the baseball game nears.

According to examples, the dispatch engine 155 can make driver selections 167 from the live driver log 165 to receive the demand notification 148 based on temporal proximity (e.g., according to traffic data 164) or physical proximity to the event location. Additionally or alternatively, the dispatch engine 155 can send a request broadcast 157 to proximate drivers 185, available or unavailable, who may be capable of servicing the predicted pick-up request spike when it occurs at a later time. In order to incentivize drivers to accept the request broadcast 157 (i.e., commit to servicing the predicted spike in pick-up requests at the event location), the dispatch engine 155 can include an incentive in the request broadcast 157. The incentive may be an individual monetary bonus or some other form of incentive, such as a gain sharing bonus for servicing the predicted pick-up spike or a noncash bonus.

The demand notification 148 may be a push notification indicating the time and location of the predicted spike in pick-up requests 182. Alternatively, the notification generator 145 can utilize map data 162 to create a demand heat map that shows the location of the event and a “hot” area of demand. Thus, the driver is informed that pick-up requests 182 are forthcoming at the event location and can plan to be close so that the dispatch engine 155 issues one or more assignments 156 to the driver to service one or more pick-up requests 182. The demand notification 148 can further include a commitment request, which a driver may accept, so that the dispatch engine 155 can keep track of the amount of drivers committed to mitigate the anticipated supply shortage at the event location.

The notification generator 145 can submit demand notifications 148 to differing groups of drivers on a time-sensitive basis. For example, the notification generator 145 can initially submit the demand notification 148 to a proximate group of available drivers. As the time of occurrence of the predicted spike in pick-up requests 182 gets nearer, the notification generator 145 can submit the demand notification 148 to a wider and wider group of drivers (e.g., a larger radius from the event location as the time for the predicted spike occurring approaches), until the dispatch engine 155 determines that the predicted spike in pick-up requests 182 may be fully or near fully mitigated.

In some examples, the dispatch engine 155 can receive pick-up requests 182 from users 180 that are not attending the event, but have requested pick-up close to the event location near the predicted time of the pick-up spike. In response to such pick-up requests, which can include location data 181 of the requesting user, the dispatch engine 155 can utilize the location data 181 to identify that the requesting user is not in attendance of the event, and submit a notification trigger 158 to the notification generator 145. The notification generator 145 can generate an avoidance notification for transmission to the requesting user, which can warn the requesting user of the anticipated spike in demand. Such an avoidance notification can instruct the user to request pick-up at a location a few blocks away from the event location so as to avoid the area and the potential crowds and traffic.

In certain variations, the dispatch engine 155 can utilize the traffic data 164 to identify ideal locations for picking up requesting users around the event location. Accordingly, the demand notification 148 can include a suggested pick-up location for drivers to location themselves when the event is complete. Furthermore, upon receiving a pick-up request 182 from a user, the dispatch engine 155 can suggest that the user walk to a suggested location around the event location in order to more efficiently service the actual spike in pick-up requests 182.

When the event is completed, pick-up requests 182 may be received and serviced more efficiently since drivers have been notified of the predicted demand spike and have made their way to the event location accordingly. The dispatch engine 155 can assign 156 drivers to each pick-up request 182 and submit confirmations 179 to the requesting users indicating the assigned driver and the pickup location. Pick-up data 177 for the event may be received and analyzed by the matching engine 120 to calculate an accuracy factor in the prediction. Such accuracy factors may be incorporated in the spike pairs for each correlation model 133 in order to support further predictions for future drop-off spikes.

### Methodology

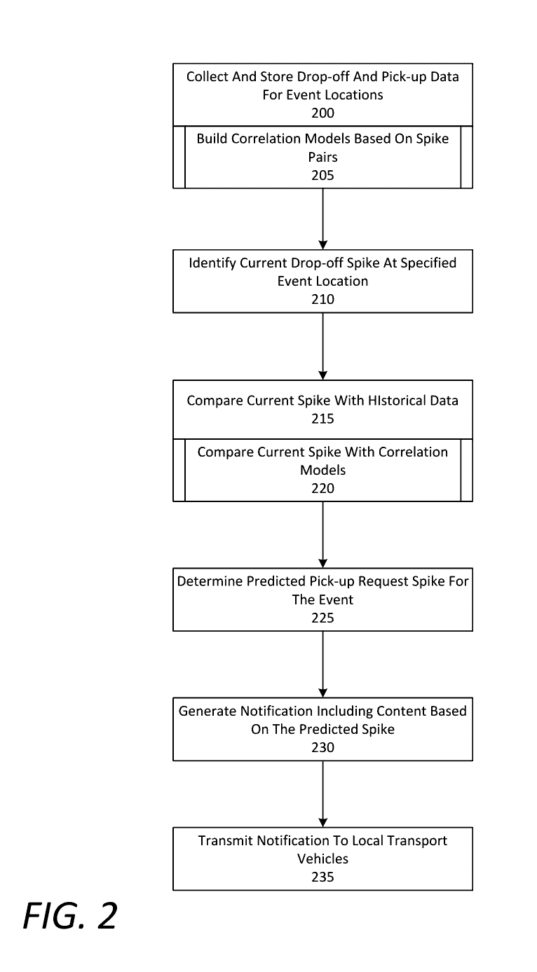

FIG. 2 is a high level flow chart illustrating an example method for predicting and servicing pick-up request spikes at a given event location. In the below description of FIG. 2, reference may be made to like reference characters representing various features of FIG. 1 for illustrative purposes. Furthermore, the high level method described in connection with FIG. 2 may be performed by an example dispatch system 100 as illustrated in FIG. 1. Referring to FIG. 2, the dispatch system 100 can collect and store historical drop-off data 176 and pick-up data 177 for a variety of event locations (200). From the drop-off data 176 and pick-up data 177, the dispatch system 100 can recognize various patterns, such as drop-off spikes and associated pick-up spikes for a given event location. In some examples, the dispatch system 100 can build correlation models 133 based on the identified spike pairs (205). For example, the dispatch system 100 can identify similar spike pairs corresponding to professional baseball games at a specified ballpark. These spike pairs may have similar attributes, such as volume of drop-offs, volume of pick-ups, volume ratio, duration, time of day, time of week, time of year, etc. Accordingly, the dispatch system 100 can incorporate these similar spike pairs into a correlation model representing professional baseball games at the particular ballpark.

At any given time, the dispatch system 100 can detect a current drop-off spike 111 at a specified event location (210). Using the characteristics of the current drop-off spike 111 (e.g., location, volume, time, etc.), the dispatch system 100 can compare the current drop-off spike 111 with the stored historical data to (215). For example, the dispatch system 100 can compare the current drop-off spike 111 with the correlation models 133 to identify a matching correlation model 134 (220). Based on the historical data and/or the matching correlation model 134, the dispatch system 100 can determine or calculate a predicted pick-up request spike for the event (225). Based on the predicted spike in pick-up requests 182, the dispatch system can generate a demand notification 148 including content indicative of the predicted spike in passenger pick-up requests (230). At a given time after the current spike in passenger drop-offs, the dispatch system 100 can transmit the demand notification 148 to proximate transport vehicles to notify the drivers of the anticipated spike in demand (235). As an addition or an alternative, the dispatch system 100 can also transmit a notification to users that are nearby the event location to inform them about the anticipated spike in demand at the event location.

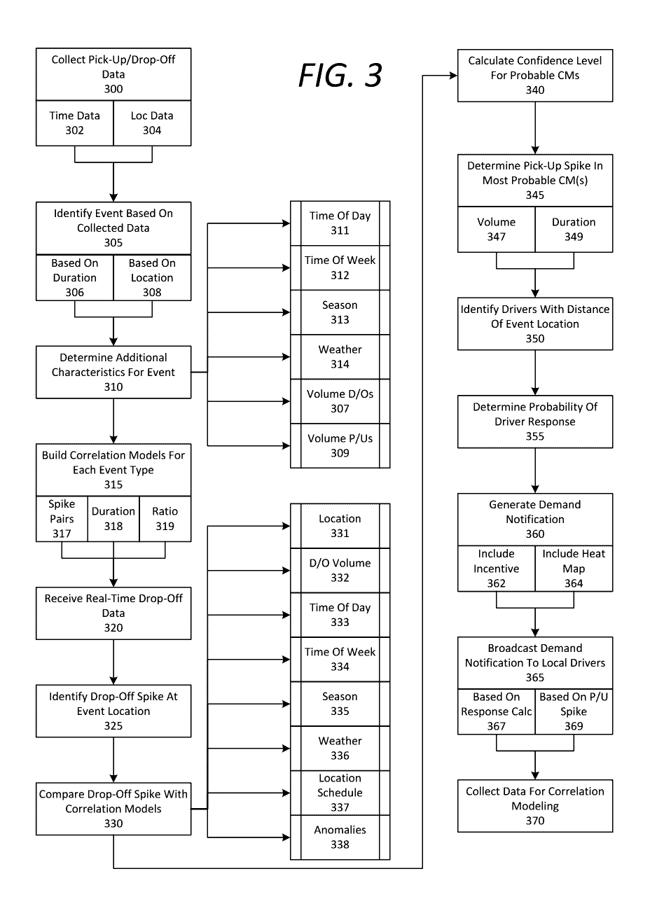

FIG. 3 is a low level flow chart illustrating an example method for predicting and servicing pick-up request spikes at a given event location. In the below description of FIG. 3, reference may be made to like reference characters representing various features of FIG. 1 for illustrative purposes. Furthermore, the low level method described in connection with FIG. 3 may also be performed by an example dispatch system as illustrated in FIG. 1. Referring to FIG. 3, the dispatch system 100 can collect and store passenger drop-off data 176 and passenger pick-up data 177 (300). The dispatch system can collect such data in conjunction with time data (302) for each drop-off and pick-up event, and location data (304) for each drop-off and pick-up event.

According to examples, the dispatch system 100 can identify events based on the collected data (305). For example, the collected data may indicate a spike pair. The dispatch system 100 can identify the event based on the duration of the event (306) and/or the location of the event (308). Furthermore, the dispatch system 100 can utilize network resources, such as third-part resources, to determine additional characteristics for the event. For example, the dispatch system can identify a time of day (311), a time of week (312), a time of year or season (313), the weather during the event (314), the volume of drop-offs for the event (307), the volume of pick-ups for the event (309), and/or a ratio between the respective volumes. Other data may be further indicative of the event, such as user reviews or news reports from third party resources, etc.

Using the collected data and the identified event characteristics 131, the dispatch system 100 can build correlation models 133 for each event type at each event location (315). Each correlation model 133 can be constructed to include identified spike pairs (317) for similar events, a range for the event duration (318), and a range for a volume ratio between drop-off and pick-up spikes (319). Finer details may be included in each correlation model, including the additional characteristics described above.

In various examples, the dispatch system 100 can receive real-time drop-off data (320). The real-time drop-off data can indicate a current drop-off spike 111 at an event location, which can be identified by the dispatch system 100 (325). Based on the characteristics of the current drop-off spike 111, the dispatch system 100 can compare the current drop-off spike 111 with the constructed correlation models 133 (330). Various characteristics of the current drop-off spike may be utilized to filter the correlation models and find a match. Specifically, the dispatch system 100 can compare various features such as the event location (331) and the drop-off volume (332) to filter away nonmatching correlation models. The dispatch system 100 may further account for matching times of day (333), times of the week (334) (e.g., Saturday for collegiate football games), and the time of the year or season (335). For example, if the current drop-off spike 111 is being detected any time from mid-February to August, the dispatch system 100 can exclude all correlation models associated with professional football games, which has a sporting season from September through January.

In some examples, the dispatch system 100 can further parse through the correlation models 133 based on weather data (336), a location schedule from a third-party source (337) (e.g., a sporting schedule for a venue website), and various other anomalies (338) described herein. When one or more matching correlation models 134 are identified, the dispatch system can calculate a confidence score for each matching correlation model (340). Various factors can be determinative of a high confidence score, such as a tightly matched drop-off and pick-up spike pair. Static variables such as event location and, in some examples, event duration, may also result in a high confidence score. Variable factors such as volume ratio or time of day may not hold as much weight. Thus, based on the highest probable match(es), the dispatch system 100 can determine and predict a pick-up request spike from the most probable correlation model(s) (345). The predicted pick-up request spike can include a given duration after the detected current drop-off spike (349) and a given volume comprising a predicted number of pick-up requests 182 (347).

Once the predicted pick-up request spike is calculated, the dispatch system can identify drivers, based on location and availability, within a distance or time of the event location (350). The dispatch system 100 can further determine a probability of driver response to a demand request notification 148 (355). For example, the dispatch system 100 may identify a supply shortage of 400 drivers for a given event. The dispatch system 100 may calculate, based on historical data, that only around 50% of drivers respond or commit to a demand notification 148. Accordingly, the dispatch system 100 can generate and broadcast demand notifications 148 to a number of drivers (e.g., 800 drivers in the example) in order to mitigate the supply shortage (360, 365). The demand notification 148 can be generated to include an incentive (362) such as a monetary or nonmonetary bonus. Furthermore, the dispatch system 100 can include a demand heat map on the notification (364), to enable available drivers to anticipate locating themselves strategically to receive request assignments 156.

Furthermore, the demand notifications 148 can be broadcasted (365) based on the probability of response calculation (367), as provided above, and based on servicing the predicted pick-up request spike at the event location (369). When the event concludes and actual pick-up requests 182 start being received and assigned to the available drivers, the dispatch system 100 can collect additional data to determine an accuracy of the prediction, and to provide further data inputs for the correlation models 133 (370).

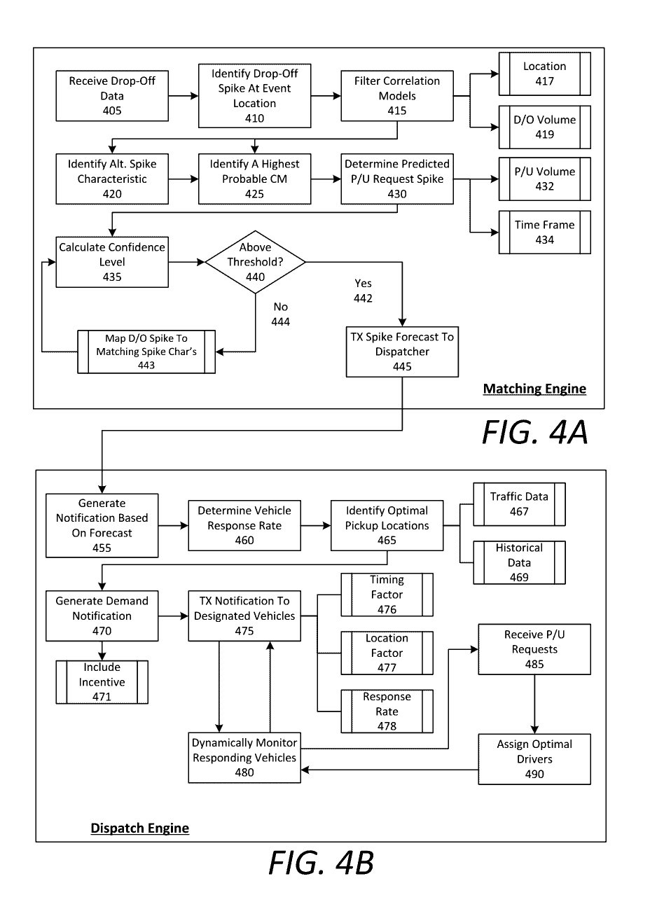

FIG. 4A is a flow chart illustrating an example method for matching a current drop-off spike with a correlation model. The below examples described with respect to FIG. 4A may be performed by, for example, the matching engine 140 as described in connection with FIG. 1. Referring to FIG. 4A, the matching engine 140 of the dispatch system 100 can receive passenger drop-off data 176 (405) and identify a drop-off spike at an event location (410). Based on the event location (417) and the volume of drop-offs (419), the matching engine 140 can filter through the correlation models (415). If a match is not found, the matching engine 140 can identify one or more alternative characteristics of the current drop-off spike (420) to further filter through the correlation models (e.g., event schedules, weather, news reports, user reviews, and the like).

The matching engine 140 may then identify a highest probable correlation model based on the current drop-off spike (425). The matching engine 140 can then determine a predicted pick-up request spike based on the highest probable correlation model (430). In some examples, the matching engine 140 can calculate a mathematical expectancy for the predicted pick-up request spike based on individual spike pairs in the correlation model, or parse through the individual spike pairs to identify one or more most closely matching spike pairs. The predicted spike in pick-up requests 182 can include a selected volume of pick-up requests (432) as well as a selected duration or time frame after the detected drop-off spike (434).

For multiple predicted pick-up request spikes, the matching engine 140 can calculate a confidence level for each spike based on weightings for various factors (435). For example, the volume ratio or drop-off volume may be weighted more than a predicted duration. The matching engine 140 can then determine whether the predicted pick-up request spike has a confidence level above a certain threshold (440). If not (444), the predicted spike may be discarded, or individual characteristics of the current drop-off spike may be mapped to the same characteristics of the predicted pick-up spike (443) The matching engine 140 can then calculate a confidence score for each characteristic (435) and determine whether these individual or combination of characteristics meet a predetermined threshold (440). If the predicted pick-up spike exceeds the predetermined threshold (442), then the matching engine can generate and transmit a spike forecast 144 to the dispatch engine 155 for processing (445).

FIG. 4B is a flow chart illustrating an example method for transmitting demand notifications to transport vehicles based on a given spike forecast. The examples described with respect to FIG. 4B may be performed by, for example, the dispatch engine 155 of FIG. 1. Referring to FIG. 4B, the dispatch engine 155 can receive the spike forecast 144 and generate a notification to drivers based on the spike forecast 144 (455). The initial notification can indicate that a local event is predicted to create an increased demand for driver services. Furthermore, the initial notification may be transmitted to all available or potentially available transport vehicles within a predetermined distance of the event location.

The dispatch engine 155 can then identify a supply shortage and determine a vehicle response rate based on historical data (460). The dispatch engine 155 can also identify optimal pick-up locations around the event location (465). These optimal locations can be determined based on current traffic data (467), and/or historical data (469). Once the event location and predicted response rate are determined, along with current available drivers and service traffic, the dispatch engine 155 can generate a demand notification 148 for transmission to select drivers (470, 475). The demand notification 148 can include an incentive (471) to elicit drivers to commit to responding the predicted spike in pick-up requests 182. The dispatch engine 155 can identify to which specific drivers to send the demand notification 148 based on a time factor corresponding to an estimated time the driver will take to reach the event location (476). Additionally or alternatively, the dispatch engine 155 can select drivers based on location and proximity to the event location (477), as well as the determined response rate (478).

Once the demand notification 148 is transmitted to the initial set of drivers, the dispatch engine 155 can dynamically monitor the responding vehicles (480). If the number of vehicles responding to the demand notification 148 does not amount to a full or near full mitigation of the predicted supply shortage, the dispatch engine 155 can transmit the demand notification 148 to additional vehicles until a satisfactory set of vehicles have committed (475). Accordingly, upon conclusion of the event, the dispatch engine 155 can receive pick-up requests 182 from requesting users 180 (485), and assign optimal drivers to service those requests (490). During operation, the dispatch engine 155 can continue to dynamically monitor the responding vehicles (480), suggesting grouped rides, reassigning drivers, and/or chaining rides where possible.

### Screenshot Examples

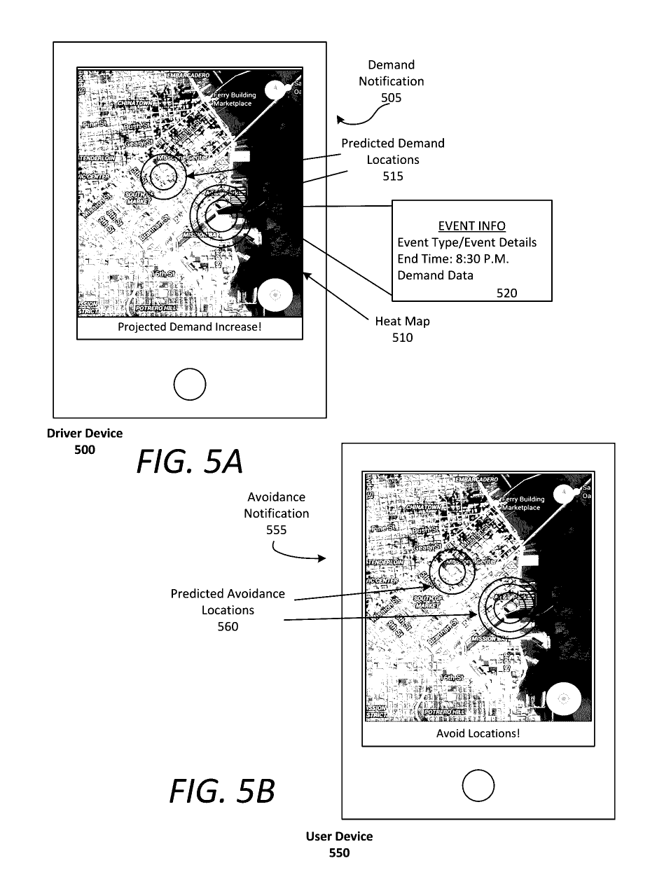

FIG. 5A is an example screenshot of a demand notification for a driver device. In the example provided, a driver of an available or unavailable transport vehicle may be notified of the predicted spike in passenger pick-up requests by way of a demand notification 505 being transmitted to the driver's device 500 (e.g., the driver's mobile computing device running a designated application). When the dispatch system 100 identifies a current spike in drop-offs at one or more event locations, the dispatch system 100 can generate the demand notification 505 for transmission to a number of transport vehicles. The demand notification 505 can include indicators showing the predicted demand locations 515, and/or a heat map 510 providing a visual indication of demand areas. The demand notification 505 can also include a number of selectable features. For example, each indicated demand location can be selectable to show event information 520 for the given event. In the example provided, the event information 520 includes the event type and event details (e.g., “baseball game: Giants versus Cubs”), and predicted end time for the event (e.g., 8:30 p.m.), and demand data (e.g., a volume of predicted pick-up requests). As an alternative, the event information 520 may be displayed on the demand notification 505, for example, in conjunction with the heat map 510.

FIG. 5B is an example screenshot of an avoidance notification for a user device. The avoidance notification 555 can be triggered by a pick-up request from a user proximate to an event. For example, the dispatch system 100 can respond to a user requesting a pick-up close to an event location, and near the predicted end time for the event. In response to the pick-up request, the dispatch system 100 can identify that the user is not currently located at the event, and can transmit the avoidance notification 555 to the user's device 550. The avoidance notification 555 can indicate the predicted avoidance locations 560 to the user. In some variations, the predicted avoidance locations 560 can be selectable to display the event information for the selected event, such as the event information 520 as shown in FIG. 5A. Alternatively, the avoidance notification 555 can include the event information on, for example, a heat map. Accordingly, the user can select an alternative pick-up location based on the avoidance notification 555.

### Hardware Diagrams

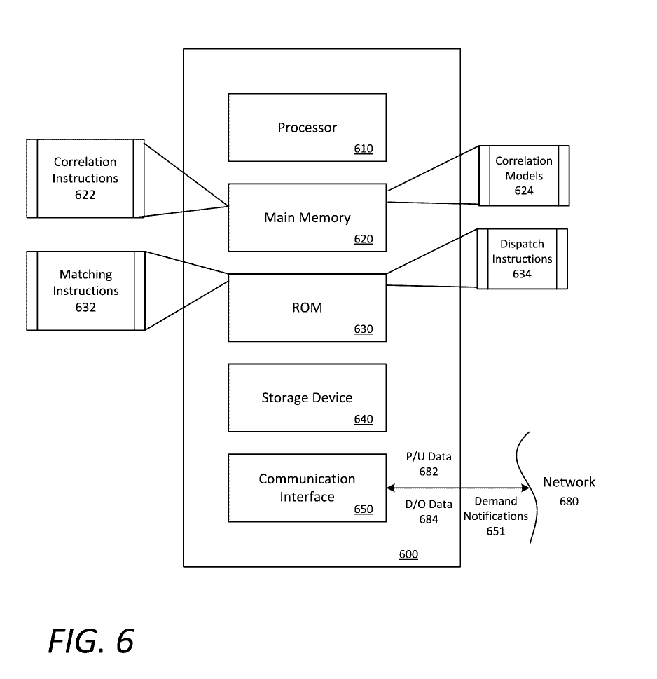

FIG. 6 is a block diagram that illustrates a computer system upon which examples described herein may be implemented. A computer system 600 can be implemented on, for example, a server or combination of servers. For example, the computer system 600 may be implemented as part of a network service for providing transportation and on-demand delivery services. In the context of FIG. 1, the dispatch system 100 may be implemented using a computer system such as described by FIG. 6. The dispatch system 100 may also be implemented using a combination of multiple computer systems as described in connection with FIG. 6.

In one implementation, the computer system 600 includes processing resources 610, a main memory 620, a read-only memory (ROM) 630, a storage device 640, and a communication interface 650. The computer system 600 includes at least one processor 610 for processing information stored in the main memory 620, such as provided by a random access memory (RAM) or other dynamic storage device, for storing information and instructions which are executable by the processor 610. The main memory 620 also may be used for storing temporary variables or other intermediate information during execution of instructions to be executed by the processor 610. The computer system 600 may also include the ROM 630 or other static storage device for storing static information and instructions for the processor 610. A storage device 640, such as a magnetic disk or optical disk, is provided for storing information and instructions.

The communication interface 650 enables the computer system 600 to communicate with one or more networks 680 (e.g., cellular network) through use of the network link (wireless or a wire). Using the network link, the computer system 600 can communicate with one or more computing devices, and one or more servers. In accordance with examples, the computer system 600 receives pick-up data 682 and drop-off data 684 from mobile computing devices of individual users. The executable instructions stored in the memory 630 can include correlation instructions 622, which the processor 610 executes to correlate identified drop-off spikes with associated pick-up spikes, and spike pairs with additional event data, to construct correlation models for given event types. The executable instructions stored in the memory 630 can also include matching instructions 632, which enables the computer system 600 to identify a matching correlation model given an identified spike in passenger drop-offs. The executable instructions stored in the memory 630 can also include dispatch instructions 634 to generate demand notifications and assign transport vehicles to service a predicted spike in pick-up requests. The memory 630 can include correlation models 624 that can be parsed to identify a matching spike pair for a current drop-off spike. By way of example, the instructions and data stored in the memory 630 can be executed by the processor 610 to implement an example dispatch system 100 of FIG. 1. In performing the operations, the processor 610 can generate and send demand notifications 651 via the communication interface 650 to the mobile computing devices of the drivers.

The processor 610 is configured with software and/or other logic to perform one or more processes, steps and other functions described with implementations, such as described by FIGS. 1-4, and elsewhere in the present application.

Examples described herein are related to the use of the computer system 600 for implementing the techniques described herein. According to one example, those techniques are performed by the computer system 600 in response to the processor 610 executing one or more sequences of one or more instructions contained in the main memory 620. Such instructions may be read into the main memory 620 from another machine-readable medium, such as the storage device 640. Execution of the sequences of instructions contained in the main memory 620 causes the processor 610 to perform the process steps described herein. In alternative implementations, hard-wired circuitry may be used in place of or in combination with software instructions to implement examples described herein. Thus, the examples described are not limited to any specific combination of hardware circuitry and software.

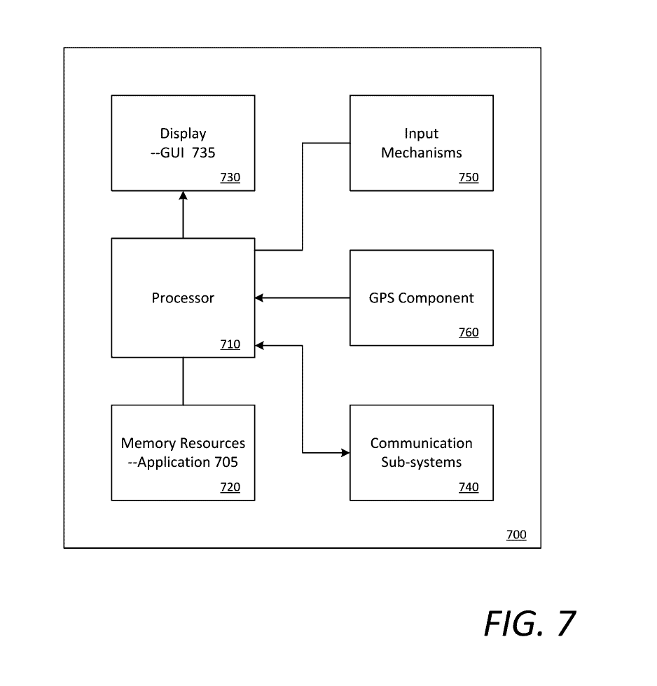

FIG. 7 is a block diagram that illustrates a mobile computing device upon which examples described herein may be implemented. In one example, a mobile computing device 700 may correspond to, for example, a cellular communication device (e.g., feature phone, smartphone etc.) that is capable of telephony, messaging, and/or data services. In variations, the mobile computing device 700 can correspond to, for example, a tablet or wearable computing device. Still further, the mobile computing device 700 can be distributed amongst multiple portable devices of drivers, and requesting users.

In an example of FIG. 7, the computing device 700 includes a processor 710, memory resources 720, a display device 730 (e.g., such as a touch-sensitive display device), one or more communication sub-systems 740 (including wireless communication sub-systems), input mechanisms 750 (e.g., an input mechanism can include or be part of the touch-sensitive display device), and one or more location detection mechanisms (e.g., GPS component) 760. In one example, at least one of the communication sub-systems 740 sends and receives cellular data over data channels and voice channels.

A driver of a transport vehicle can operate the mobile computing device 700 when on a shift to provide transportation services. The memory resources 720 can store one or more applications 705 for linking the mobile computing device 700 with a network service that enables or otherwise facilitates the drivers' ability to efficiently service pick-up requests. Execution of the application 705 by the processor 710 may cause a specified graphical user interface (GUI) 735 to be generated on the display 730. Interaction with a driver GUI 735 can enable drivers of transport vehicles to receive assignments to service pick-up requests or perform a pickup and/or drop-off. Further still, interaction with a requestor GUI can enable requesting users to request a pick-up for transportation service to a selected destination.

While examples of FIG. 6 and FIG. 7 provide for a computer system 600 and mobile computing device 700 for implementing aspects described, in some variations, the mobile computing device 700 can operate to implement some or all of the functionality described with the dispatch system 100.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude claiming rights to such combinations.

What is claimed is:

1. A dispatch system comprising:
one or more processors; and
one or more memory resources storing instructions that, when executed by the one or more processors, cause the dispatch system to:
store historical data corresponding to passenger drop-offs and passenger pick-ups at a number of event locations;
in real-time, identify a current spike in passenger drop-offs for a given event at a specified one of the event locations;
based on the current spike in passenger drop-offs, predict, using the historical data, a spike in passenger pick-up requests at the specified event location and at a predicted end time for the given event; and
generate a notification for transmission to a number of transport vehicles, the notification comprising content indicating the predicted spike in passenger pick-up requests.

2. The dispatch system of claim 1, wherein the instructions, when executed by the one or more processors, further cause the dispatch system to:
using the historical data, construct correlation models each comprising a set of spike pairs, wherein each of the spike pairs comprises a spike in passenger drop-offs and a spike in passenger pick-ups at a respective one of the event locations;
wherein the executed instructions cause the dispatch system to predict the spike in passenger pick-up requests by (i) filtering through the correlation models using the current spike in passenger drop-offs, and (ii) identifying one or more matching correlation models that matches the current spike in passenger drop-offs.

3. The dispatch system of claim 2, wherein each of the correlation models identifies (i) a common volume of passenger drop-offs and passenger pick-ups for each of the spike pairs, (ii) a common event location, and wherein the executed instructions cause the dispatch system to filter through the correlation models by (i) comparing the current spike in passenger drop-offs with the common volume of passenger drop-offs for each of the correlation models, and (ii) comparing the specified location of the given event with the common event location for each of the correlation models.

4. The dispatch system of claim 3, wherein each of the correlation models further identifies (i) a common duration between the spike pairs, and (ii) a common ratio between passenger drop-offs and passenger pick-up requests for the spike pairs, and wherein the executed instructions cause the dispatch system to predict the spike in passenger pick-up requests by (i) determining a duration after the current spike in drop-offs based on the common duration between the spike pairs for the one or more matching correlation models, and (ii) determining a volume for the predicted spike in passenger pick-up requests based on the common ratio between passenger drop-offs and passenger pick-up requests for the one or more matching correlation models.

5. The dispatch system of claim 2, wherein each of the correlation models further identifies a common event type, and wherein the executed instructions cause the dispatch system to filter through the correlation models by (i) determining, via a third party resource, a current event type for the current spike in passenger drop-offs, and (ii) disregarding correlation models having a different event type than the current event type.

6. The dispatch system of claim 2, wherein the instructions, when executed by the one or more processors, further cause the dispatch system to:
select a most probable correlation model from the one or more matching correlation models; and
determine, from the set of spike pairs of the most probable correlation model, the predicted spike in passenger pick-up requests.

7. The dispatch system of claim 6, wherein the executed instructions cause the dispatch system to determine the predicted spike in passenger pick-up requests by (i) identifying an expected time period between the spike pairs in the most probable correlation model, and (ii) determining a volume for the predicted spike in passenger pick-up requests based on the spike pairs in the most probable correlation model.

8. The dispatch system of claim 2, wherein each of the spike pairs in each correlation model is associated with weather conditions for both the spike in passenger drop-offs and the spike in passenger pick-ups at the respective event location.

9. The dispatch system of claim 8, wherein the instructions, when executed by the one or more processors, further cause the dispatch system to:
identify current weather conditions for the current spike in passenger drop-offs at the specified event location;
wherein the executed instructions cause the dispatch system to select the based on the weather conditions for the spike in passenger drop-offs of the most probable correlation model matching the identified current weather conditions.

10. The dispatch system of claim 1, wherein the instructions, when executed by the one or more processors, further cause the dispatch system to:
receive, from a user device, a request for a passenger pick-up within a threshold distance of the specified event location and within a threshold time of the predicted end time;
determine, from location-based resources of the user device, that the user device is not currently located at the specified event location; and
based on the user device not being currently location at the specified event location, generate and transmit an avoidance notification to the user device, the avoidance notification suggesting to the user to avoid the specified event location due to the predicted spike in pick-up requests at the predicted end time for the given event.

11. The dispatch system of claim 1, wherein the instructions, when executed by the one or more processors, further cause the dispatch system to:
prior to the predicted end time of the given event, identify a number of available transport vehicles within a predetermined distance or time from the specified event location;
calculate a predicted supply shortage between the predicted spike in pick-up requests and the identified number of available transport vehicles; and
transmit the notification to the identified available transport vehicles and a plurality of additional transport vehicles in anticipation of the predicted supply shortage.

12. The dispatch system of claim 11, wherein the instructions, when executed by the one or more processors, further cause the dispatch system to:
determine current traffic conditions for the respective event location; and
based on the current traffic conditions, identify a plurality of optimal pick-up locations surrounding the specified event location to optimize traffic conditions at the predicted end time for the given event.

13. The dispatch system of claim 11, wherein the instructions, when executed by the one or more processors, further cause the dispatch system to:
receive confirmations from responsive transport vehicles of the identified available transport vehicles and the plurality of additional transport vehicles;
receive a number of pick-up requests from the specified event location at an actual end time for the given event, each of the pick-up requests originating from a requesting user device and specifying a pick-up location; and
in response to each of the pick-up requests, assign an optimal one of the responsive transport vehicles to the pick-up request.

14. The dispatch system of claim 13, wherein the instructions, when executed by the one or more processors, further cause the dispatch system to:
generate and transmit a response notification to the requesting user device, the response notification indicating one or more of the plurality of optimal pick-up locations to meet the assigned the optimal responsive transport vehicle.

15. The dispatch system of claim 1, wherein the given event corresponds to one of an entertainment event or a conference event.

16. The dispatch system of claim 15, wherein the entertainment event corresponds to one of a sporting event, a concert event, or a holiday event.

17. The dispatch system of claim 1, wherein the generated notification comprises a heat map indicating the predicted spike in pick-up requests for the respective event location at the predicted end time.

18. The dispatch system of claim 1, wherein the instructions, when executed by the one or more processors, further cause the dispatch system to:
transmit the generated notification to all available transport vehicles within a threshold distance of the specified event location, the generated notification including an incentive for drivers of the available transport vehicles to service the predicted spike in passenger pick-up requests.

19. A method for dispatching transport vehicles comprising:
storing historical data corresponding to passenger drop-offs and passenger pick-ups at a number of event locations;
in real-time, identifying a current spike in passenger drop-offs for a given event at a specified one of the event locations;
based on the current spike in passenger drop-offs, predicting, using the historical data, a spike in passenger pick-up requests at the specified event location and at a predicted end time for the given event; and
generating a notification for transmission to a number of transport vehicles, the notification comprising content indicating the predicted spike in passenger pick-up requests.

20. A non-transitory computer readable medium storing instructions that, when executed by one or more processors, cause the one or more processors to:
store historical data corresponding to passenger drop-offs and passenger pick-ups at a number of event locations;
in real-time, identify a current spike in passenger drop-offs for a given event at a specified one of the event locations;
based on the current spike in passenger drop-offs, predict, using the historical data, a spike in passenger pick-up requests at the specified event location and at a predicted end time for the given event; and
generate a notification for transmission to a number of transport vehicles, the notification comprising content indicating the predicted spike in passenger pick-up requests.
